(19) United States
(12) Patent Application Publication
(10) Pub. No.: US 2008/0039967 A1
(43) Pub. Date: Feb. 14, 2008

(54) System and method for delivering interactive audiovisual experiences to portable devices

(76) Inventor: Greg Sherwood, Inverness, IL (US)

Correspondence Address: PATENTS+TMS, P.C., 2849 W. ARMITAGE AVE., CHICAGO, IL, 60647, US

(21) Appl. No.: 11/890,745

(22) Filed: Aug. 7, 2007

Related U.S. Application Data
(60) Provisional application No. 60/837,370, filed on Aug. 11, 2006.

(51) Int. Cl. G06F 17/00

(52) U.S. Cl. 700/94

(57) ABSTRACT

A system and a method for transmitting and receiving audiovisual media are provided. The system provides a network for transmitting audiovisual media and dynamic elements to a multimedia node which is connected to an electronic device, such as, for example, a portable electronic device. The audiovisual media is streaming audiovisual media, dynamic audiovisual media, interactive audiovisual media and/or dynamic and interactive audiovisual media scenes. Further, the network and the multimedia node transfer and receive dynamic elements and audiovisual media. The multimedia node transmits dynamic elements to the network which transmits the audiovisual media based on the dynamic elements received by the network. The multimedia node outputs a multimedia scene which incorporates the dynamic elements and the audiovisual media. Multiple users may access the network, the audiovisual media and/or the dynamic elements.

This application claims the benefit of U.S. Provisional Patent Application Ser. No. 60/837,370 filed on Aug.11, 2006.

### BACKGROUND OF THE INVENTION

The present invention generally relates to a system and a method for delivering interactive audiovisual experiences to portable devices. More specifically, the present invention relates to a system and a method for delivering interactive audiovisual experiences to portable devices which may combine audiovisual media with interactive and/or dynamic elements to deliver the interactive audiovisual experiences on a portable device. Rather than simply viewing the audiovisual media, the present invention allows a user of the portable device to interact with the audiovisual media in real time to create an interactive audiovisual experience which may be unique to the user.

The system may have a network which may be in communication with a multimedia node on a portable device. The network may transmit and/or may deliver audio media, visual media and/or audiovisual media to the portable device. Furthermore, the portable device may access the network to receive interactive and/or dynamic media elements, such as, for example, animations, pictures, graphical elements, text, data and/or the like. The portable device may transmit the audiovisual media which may be captured and/or may be stored on the portable device to the network. The portable device may transmit, for example, user interactions, such as, for example, pushing of a key and/or a button on the portable device to the network.

In an embodiment, the user of the portable device provides feedback which may be transmitted to the network and may modify, for example, the audiovisual media received by the portable device. Furthermore, the portable device may receive the audiovisual media and/or interactive elements, such as, for example, graphics, text and/or animation to output a multimedia scene representing a game, a contest or other interactive experience to the user of the portable device. The multimedia scene may combine graphical elements of, for example, video games and/or other entertainment experiences with the reality of natural audio and/or visual scenes.

In another embodiment, multiple users may access, may interact with and/or may view the multimedia scene. To this end, the portable device provides a multi-user experience in which each of the users may receive and/or may view visual representations of other users accessing, transmitting and/or interacting with the multimedia scene. As a result, the users may interact by, for example, competing, cooperating and/or the like.

It is generally known to transmit and/or to receive audiovisual media data from a network, such as, for example, the Internet. The audiovisual media may be, for example, digital media files, streaming video, streaming audio, text, graphics and/or the like. The network may transmit the audiovisual media to an electronic device, such as, for example, a personal computer, a laptop, a cellular telephone, a personal digital assistant, a portable media player, and/or the like. The electronic device may receive the multimedia and may output the multimedia for consumption by a user of the electronic device. Typically, the electronic device may be formatted for accessing multimedia of a first type and/or a first format. If the electronic device is incompatible with the audiovisual media and/or is not formatted to access the audiovisual media, the user of the electronic device cannot consume the audiovisual media via the electronic device. Furthermore, the electronic device may be formatted for accessing audiovisual media of a second type and/or a second format. As a result, the electronic device is required to be formatted for accessing audiovisual media of the first type and/or the second type. Alternatively, the electronic device is required to store data and/or information to convert the audiovisual media of the first type to the audiovisual media of the second type.

Moreover, portable electronic devices generally consist of video nodes and/or audio nodes which are limited to passively receiving audiovisual media and/or data from the network. That is, data is received, decoded and delivered to a display and/or an audio output of the portable electronic device for consumption by the user. The interactivity of the user with the audiovisual media is limited to selecting a portion of the audiovisual media to consume, adjusting the volume or picture characteristics of the audiovisual media, playing, stopping, pausing, scanning forward or scanning forward or backward in the audiovisual media. The audiovisual media does not change as a result of any user action. That is, the audio nodes an/or the video nodes do not support dynamic and/or interactive transmission of the data and/or the audiovisual media between the network and the portable electronic device.

Furthermore, portable electronic devices typically have constrained environments, such as, for example, processing units with limited capacities, memories having limited storage capacities and/or the like. The constrained environments of the portable electronic devices prevent a first portable electronic device and a second portable electronic device from sharing in a common dynamic audiovisual media and/or interactive audiovisual media experience via the network. Therefore, multi-user interactive audiovisual media experiences based on natural audio and video are impossible.

A need, therefore, exists for a system and a method for delivering interactive audiovisual experiences to portable devices. Additionally, a need exists for a system and a method for delivering interactive audiovisual experiences to portable devices which may transmit and/or may receive dynamic and/or interactive audiovisual media via a network. Further, a need exists for a system and a method for delivering interactive audiovisual experiences to portable devices which may interact with and/or may modify a audiovisual media stream or transmission in substantially real time based on feedback from users of the portable devices. Still further, a need exists for a system and a method for delivering interactive audiovisual experience to portable devices which may synchronize commands input into the portable devices with audiovisual media and/or data sent from the network to create an engaging experience for the user. Moreover, a need exists for a system and a method for delivering interactive audiovisual experiences to portable devices which may allow a first portable electronic device and a second portable electronic device to simultaneously participate in an interactive audiovisual experiences via the network.

### SUMMARY OF THE INVENTION

The present invention generally relates to a system and a method for delivering interactive audiovisual experiences to portable devices. More specifically, the present invention relates to a system and a method for delivering interactive audiovisual experiences to a portable device which may transmit audiovisual media and interactive elements and/or dynamic elements to a network. A multimedia node may be connected to, may be in communication with and/or may be incorporated into the portable device. The system may have a network which may be in communication with a multimedia node on a portable device. The multimedia node may transmit user interactions to the network. Furthermore, the network may transmit the audiovisual media, the interactive elements and/or the dynamic elements associated with and/or corresponding to the user interactions to the multimedia node and/or the portable device. In addition, the portable device may output a multimedia scene representing the interactive audiovisual experience to the user of the portable device. The multimedia scene may incorporate and/or may combine the audiovisual media, the interactive and/or the dynamic elements. Multiple users may access an/or may communicate with the network simultaneously to receive and/or to transmit and/or to receive the interactive audiovisual experiences.

It is, therefore, an advantage of the present invention to provide a system and a method for delivering interactive audiovisual experiences to portable devices.

Another advantage of the present invention is to provide a system and a method for delivering interactive audiovisual experiences to portable devices which may deliver interactive elements and/or dynamic elements to a network.

And, another advantage of the present invention is to provide a system and a method for delivering interactive audiovisual experiences to portable devices which may have a multimedia node for outputting a multimedia scene to a portable device.

Yet another advantage of the present invention is to provide a system and a method for delivering interactive audiovisual experiences to portable devices which may have a multimedia node which may transmit and/or may receive audiovisual media corresponding to user interactions input into a portable device.

A further advantage of the present invention is to provide a system and a method for delivering interactive audiovisual experiences to portable devices which may have a multimedia node for transmitting and/or receiving audiovisual media, dynamic elements and/or interactive elements for outputting a multimedia scene to a portable device.

Moreover, an advantage of the present invention is to provide a system and a method for delivering interactive audiovisual experiences to portable devices which may have a network for transmitting and/or receiving audiovisual media from a first portable device and/or a second portable device.

And, another advantage of the present invention is to provide a system and a method for delivering interactive audiovisual experiences which may transmit user interactions to a network to deliver a unique interactive audiovisual experience to a user of a portable device.

Yet another advantage of the present invention is to provide a system and a method for delivering interactive audiovisual experiences to portable devices which may modify audiovisual media based on user interactions.

Another advantage of the present invention is to provide a system and a method for delivering interactive audiovisual experiences to portable devices which may have a multimedia node for modifying an multimedia scene and/or audiovisual media to output a unique interactive audiovisual experience to a user of a portable device.

Yet another advantage of the present invention is to provide a system and a method for delivering interactive audiovisual experiences to portable devices which may transmit and/or receive audiovisual media from multiple users to produce interactive audiovisual experiences to the multiple users.

A still further advantage of the present invention is to provide a system and a method for delivering interactive audiovisual experiences to portable devices which may have a multimedia node for transmitting and/or receiving dynamic and/or interactive elements from the portable devices.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for transmitting audiovisual media from a network to a first node and/or a second node in an embodiment of the present invention.

FIG. 2 illustrates a black box diagram of a system for transmitting audiovisual media from a network and/or a streaming manager to a multimedia node in an embodiment of the present invention.

### DETAILED DESCRIPTION OF THE PREFERRED EMBODIMENTS

The present invention relates to a system and a method for delivering interactive audiovisual experiences to portable devices. More specifically, the present invention relates to a system and a method for delivering interactive audiovisual experiences to portable devices which receive user interactions from each of the portable devices. Furthermore, a portable device may be connected to and/or may be in communication with a network. The network and/or the portable devices may receive and/or may transmit interactive and/or dynamic elements of the interactive audiovisual experience. The portable device may output audiovisual media and/or interactive elements to a user of the portable device. The audiovisual media may be combined with and/or incorporated into the interactive elements to output a multimedia scene to the portable device.

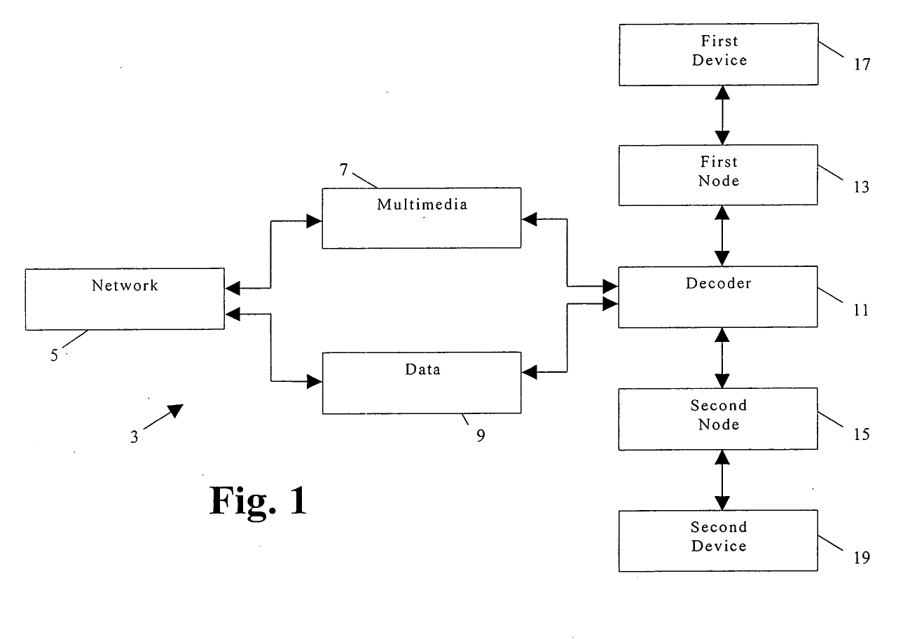

Referring now to the drawings wherein like numerals refer to like parts, FIG. 1 illustrates a system 3 for transmitting and/or receiving audiovisual media 7 and/or dynamic elements 9. The system 3 may have a network 5 which may store, may transmit and/or may receive the audiovisual media 7 and/or the dynamic elements 9. The network 5 may be connected to and/or may be in communication with a first node 13 and/or a second node 15. The first node 13 and/or the second node 15 may be connected to and/or may be incorporated into a first device 17 and/or a second device 19.

The network 5 may be a wireless network, such as, for example, a wireless metropolitan area network, a wireless local area network, a wireless personal area network, a global standard network, a personal communication system network, a pager-based service network, a general packet radio service, a universal mobile telephone service network, a radio access network and/or the like. In an embodiment, the network 5 may be, for example, a local area network, a metropolitan area network, a wide area network, a personal area network and/or the like. The present invention should not be limited to a specific embodiment of the network 5. It should be understood that the network 5 may be any network capable of transmitting and/or receiving the audiovisual media 7 and/or the dynamic elements 9 as known to one having ordinary skill in the art.

The audiovisual media 7 may be, for example, a digital audiovisual media file, such as, for example, an audio signal, video frames, a audiovisual stream and/or feed, an audio stream and/or feed, a video stream and/or feed, a musical composition, a radio program, an audio book and/or an audio program. Further, the digital audiovisual media file may be, for example, a cable television program, a satellite television program, a public access program, a motion picture, a music video, an animated work, a video program, a video game and/or a soundtrack and/or a video track of an audiovisual work, a dramatic work, a film score, an opera and/or the like. In an embodiment, the digital audiovisual media file may be, for example, one or more audiovisual media scenes, such as for example, dynamic and interactive media scenes (hereinafter “DIMS”).

The network 5, the first device 17 and/or the second device 19 may transmit and/or may receive and/or may transmit the dynamic elements 9. In an embodiment, a first portion of the dynamic elements 9 may be stored in the first device and/or the second device, and the first device and/or the second device may receive a second portion of the dynamic elements 9 from the network 5. The second portion of the dynamic elements 9 may be different in size, type and/or format than the first portion of the dynamic elements 9. The dynamic elements 9 may be, for example, interactive elements, such as, for example, animations, pictures, graphical elements, text and/or the like.

Furthermore, the dynamic elements 9 may be, data, such as, for example, software, a computer application, text, communication protocol, processing logic and/or the like. The data may be, for example, information, such as, for example, information relating to requirements and/or capabilities of the network 5, information relating to a size, a type and/or availability of the network 5, information relating to a format, a type and/or a size of the audiovisual media 7, information relating to the requirements and/or capabilities of the first node 13 and/or the second node 15 (hereinafter “the nodes 13, 15”). In an embodiment, the data may relate to and/or may be associated with information input by users (not shown) of the first device 17 and/or the second device 19. For example, the dynamic elements 9 may relate to commands and/or instructions the user inputs via input devices (not shown), such as, for example, keyboards, joysticks, keypads, buttons, computer mice and/or the like.

In addition, the dynamic elements 9 may relate to and/or may be associated with controlling access to and/or transmission of the audiovisual media 7. In an embodiment, the dynamic elements 9 may relate to and/or may be associated with software and/or applications for accessing and/or transmitting the audiovisual media 7. For example, the dynamic elements 9 may be information and/or dynamic elements related to an application accessing the audiovisual media 7.

The audiovisual media 7 and/or the dynamic elements 9 may be, for example, encoded and/or formatted into a standard format, such as, for example, extensible markup language (“XML”), scalable vector graphics (“SVG”), hypertext markup language (“HTML”), extensible hypertext markup language (“XHTML”) and/or the like. In an embodiment, the audiovisual media 7 and/or the dynamic elements 9 may be formatted for lightweight application scene representation (“LASeR”). The network 5 may transmit the dynamic elements 9 in a first format and may receive the dynamic elements 9 in a second format.

In addition, the network 5 may transmit the dynamic elements 9 in a first standard format and the dynamic elements 9 may be received by the nodes 13, 15 in a second standard format. The first standard format may be different than the second standard format. The first standard format and/or the second standard format may be based on and/or may correspond to requirements and/or capabilities of the nodes 13, 15 and/or the network 5. The nodes 13, 15 and/or the network 5 may determine which format to transmit the dynamic elements 9 and which format to receive the dynamic elements 9. In an embodiment, the nodes 13, 15 may transmit, for example, the dynamic elements 9 to the network 5 which may relate to the requirements and/or capabilities of the nodes 13, 15. The network 5 may transmit the dynamic elements 9 to the nodes 13, 15 based on the first dynamic elements received from the nodes 13, 15.

In an embodiment, the network 5 and/or the first node 13 and/or the second node 15 may, for example, encode the audiovisual media 7 and/or the dynamic elements 9. Encoding the audiovisual media 7 and/or the dynamic elements 9 may, for example, decrease a size of the audiovisual media 7 and/or the dynamic elements 9. As a result, encoding the audiovisual media 7 and/or the dynamic elements 9 may provide, for example, a higher rate of transfer of the audiovisual media 7 and/or the dynamic elements 9 between the network 5 to the first node 13 and/or the second node 15. In addition, encoding the audiovisual media 7 and/or the dynamic elements 9 may convert and/or may format the audiovisual media 7 and/or the dynamic elements 9 from, for example, the first format to the second format.

The audiovisual media 7 and/or the dynamic elements 9 may be transmitted and/or may be sent between the first node 13, the second node 15 and/or the network 5. The audiovisual media 7 and/or the dynamic elements 9 may be transmitted and/or may be received via, for example, dynamic elements communication protocols, such as, for example, voice over internet protocols (“VOIP”), transmission control protocol/internet protocols (“TCP/IP”), cellular protocols, Apple Talk protocols and/or the like. The VoIP may be, for example, a user datagram protocol (“UDP”), a gateway control protocol (e.g. Megaco H.248), a media gateway control protocol (“MGCP”), a remote voice protocol over internet protocol (“RVP over IP”), a session announcement protocol (“SAP”), a simple gateway control protocol (“SGCP”), a session initiation protocol (“SIP”), a Skinny client control protocol (“Skinny”), a digital video broadcasting (“DVB”), a bitstream in the real-time transport protocol (e.g. H.263), a real-time transport control protocol (“RTCP”), a real-time transport protocol (“RTP”) and/or the like. The TCP/IP may be, for example, a hypertext transfer protocol (“HTTP”), a real-time streaming protocol (“RTSP”), a service location protocol (“SLP”), a network time protocol (“NTP”) and/or the like.

A decoder 11 may be connected to and/or may be in communication with the network 5, the first node 13 and/or the second node 15. The decoder 11 may receive the audiovisual media 7 and/or the dynamic elements 9 from the network 5, the first node 13 and/or the second node 15. In addition, the decoder 11 may transmit and/or may send the audiovisual media 7 and/or the dynamic elements 9 to the first node 13, the second node 15 and/or the network 5. The audiovisual media 7 and/or the dynamic elements 9 may be decoded and/or may be formatted via the decoder 11. For example, the dynamic elements 9 may be decoded and/or may be converted from the first standard dynamic elements format to the second standard dynamic elements format. In an embodiment, the decoder 11 may, for example, decode and/or convert the audiovisual media 7 and/or the dynamic elements 9 from, for example, code into a bitstream and/or a signal.

Alternatively, the network 5 may transmit and/or may receive the audiovisual media 7 and/or the dynamic elements 9 from the first node 13 and/or the second node 15. Likewise, the first node 13 and/or the second node 15 may transmit and/or may receive the audiovisual media 7 and/or the dynamic elements 9 from the network 5. In an embodiment, the network 5, the first node 13 and/or the second node 15 may transmit the audiovisual media 7 and/or the dynamic elements 9 without encoding the audiovisual media 7 and/or the dynamic elements 9.

Furthermore, the first device 17 and/or the second device 19 may receive the audiovisual media 7 and/or dynamic elements 9 to output a multimedia scene 10. In an embodiment, the multimedia scene 10 may combine and/or may incorporate the audiovisual media 7 and the dynamic elements 9 to represent, for example, an interactive experience, such as, for example, a game, a contest, a movie, a ride, a play, a tour to the user of the portable device. The multimedia scene 10 may combine and/or may incorporate, for example, authentic and/or genuine audio multimedia and/or visual multimedia, such as, for example, natural audio, actual video and/or pictorial representations and/or the like. The multimedia scene 10 may correspond to and/or may be based on, for example, user interactions, such as, for example, pressing a button, turning a knob, inputting data and/or the like. For example, the user may modify and/or may control how and/or when the multimedia scene 10 is output to the first device 17 and/or the second device 19. In addition, the user of the first device 17 and/or the second device 19 may control and/or may modify a portion of the multimedia scene 10. To this end, the multimedia scene 10 may be output from the first device 17 and/or the second device 19 to provide and/or to create, for example, an interactive experience to the user of the first device 17 and/or the second device 19.

The first node 13 and/or the second node 15 may be connected to and/or may be incorporated within the first device 17 and/or the second device 19. The first device 17 and/or the second device 19 may be, for example, a mobile device, such as, for example, a 4G mobile device, a 3G mobile device, an internet protocol (hereinafter “IP”) video cellular telephone, an ALL-IP electronic device, a PDA, a laptop computer, a mobile cellular telephone, a satellite radio receiver, a portable digital audio player, a portable digital video player and/or the like.

The first node 13 and/or the second node 15 may be, for example, an input device and/or an output device, such as, for example, a processor, a processing unit, memory, a dynamic elementsbase, and/or a user interface. The input devices may be, for example, keyboards, computer mice, buttons, keypads, dials, knobs, joysticks and/or the like. The output devices may be, for example, speakers, monitors, displays, headphones and/or the like.

The first node 13 and/or the second node 15 may transmit and/or may receive the audiovisual media 7 and/or the dynamic elements 9. The nodes 13, 15 may transmit the audiovisual media 7 and/or the dynamic elements 9 to the first device 17 and/or the second device 19. The first device 17 and/or the second device 19 may store information, dynamic elements and/or software for accessing, for controlling and/or for outputting the audiovisual media 7 and/or the dynamic elements 9.

In an embodiment of a use of the system 3, the audiovisual media 7 may relate to and/or may be associated with a video game, such as, for example, a game relating to a user piloting a hot air balloon and/or an airplane. The audiovisual media 7 and/or the dynamic elements 9 may include graphics, animation and/or text which may illustrate the airplane and/or the hot air balloon traveling above a terrain. The network 5 may transmit and/or may send the audiovisual media 7 and/or the dynamic elements 9 which may include graphics, pictures, animation, motion of the airplane, the hot air balloon and/or the terrain to the nodes 13, 15. The audiovisual media 7 and/or the dynamic elements 9 may be output and/or may be displayed via the first device 17 and/or the second device 19 as the multimedia scene 10. In an embodiment, the multimedia scene 10 may be generated by simulating motion of the hot air balloon and/or the plane traveling over a large amount of the terrain which may be stored on the network 5. The nodes 13, 15, the first device 17 and/or the second device 19 may display and/or may output a portion of the terrain. To this end, the user may view the portion of the terrain to control the hot air balloon or the airplane traveling above the terrain.

The user of the first device 17 and/or the second device 19 may interact with and/or may control the multimedia scene 10. For example, the user may control the hot air balloon and/or the airplane via the first device 17, the second device 19 and/or the nodes 13, 15. The multimedia scene 10 which may be displayed by the first device 17, the second device 19 and/or the nodes 13, 15 may change based on the dynamic elements 9 that may be input by the user. For example, the user may input the dynamic elements 9 by, for example, moving a joystick, pressing a button, turning a knob and/or the like. The dynamic elements 9 may be input to, for example, decrease an altitude of the hot air balloon or the airplane. The decrease in altitude may be simulated by, for example, displaying a view of the portion of the terrain magnified from a previous view of the portion of the terrain.

In addition, the network 5 may transmit the dynamic elements 9 simultaneously with the audiovisual media 7. The network 5 may transmit the dynamic elements 9 to the nodes 13, 15, the first device 17 and/or the second device 19. The dynamic elements 9 may provide, for example, information and/or data to the user relating to the multimedia scene 10 displayed by the first device 17, the second device 19 and/or the nodes 13, 15. For example, the dynamic elements 9 may relate to a direction the airplane or the hot air balloon is traveling, such as, for example, north, northwest and/or the like. To this end, the user may control the airplane or the hot air balloon based on the dynamic elements 9.

In an embodiment, the dynamic elements 9 may be displayed and/or may be output by the first device 17, the second device 19 and/or the nodes 13, 15 simultaneously with the audiovisual media 7. For example, the dynamic elements 9 relating to the direction of the hot air balloon and/or the airplane may be displayed as, for example, a compass having an arrow pointing in the direction of travel. The compass may be displayed to the user simultaneously with the audiovisual media 7. In such an embodiment, the network 5 may control and/or may provide, for example, dynamic components and/or interactive aspects of the audiovisual media 7. To this end, the dynamic elements 9 and the audiovisual media 7 may form and/or may combine to form the multimedia scene 10.

The dynamic elements 7 transmitted from the network 5 may provide and/or may control the dynamic components and/or the interactive aspects of the audiovisual media 7. For example, the dynamic elements 7 may control which portion of the terrain the network 5 transmits to the first device 17, the second device 19 and/or the nodes 13, 15.

In addition, the user may input information, controls and/or dynamic elements to control and/or to interact with the audiovisual media 7. The user may input the dynamic elements 9 via the first device 17, the second device 19 and/or the nodes 13, 15. To this end, the user may transmit and/or may send the dynamic elements 9 to the network 5. The network 5 may transmit the audiovisual media 7 based on the dynamic elements 9 received from the first device 17, the second device 19 and/or the nodes 13, 15. For example, the user may input the dynamic elements 9 to move the hot air balloon or the airplane in a first direction. The network 5 may transmit the audiovisual media 7 which may be, for example, a scene and/or a portion of the terrain located in the first direction.

In an embodiment, the first node 13 may be incorporated into the first device 17, and the second node 15 may be incorporated into the second device 19. The second node 15 and/or the second device 19 may be in communication with the first node 13 and/or the first device 17 via the network 5. A first user (not shown) may interact with and/or may control the first device 17 and/or the first node 13. A second user (not shown) may interact with and/or may control the second device 19 and/or the second node 15. The first user may be located remotely with respect to the second user. In addition, the first node 13 and/or the first device 17 may be located remotely with respect to the second node 15 and/or the second device 19.

The first node 13 and/or the first device 17 may communicate with the network simultaneously with the second node 15 and/or the second device 19. Furthermore, the audiovisual media 7 and/or the dynamic elements 9 may be sent to and/or may be transmitted to the first node 13 and the second node 15. To this end, the first device 17 and the second device 19 may access and/or may control the audiovisual media 7 and/or the dynamic elements 9 simultaneously. To this end, the audiovisual media 7 may be accessed by the first user and the second user. The present invention should not be deemed as limited to a specific number of users, nodes and/or devices. It should be understood that the network 5 may be in communication with and/or may be connected to any number of users, nodes and/or devices as known to one having ordinary skill in the art.

For example, the first user and the second user may simultaneously access and/or simultaneously receive the audiovisual media 7 and/or the dynamic elements 9 relating to the airplane or the hot air balloon to output the multimedia scene 10. The first user may transmit the dynamic elements 9 via the first device 17 and/or the first node 13 to control a first airplane or a first hot air balloon at a first location of the audiovisual media 7. The network 5 may transmit the first node 13 and/or the first device 17 the audiovisual media 9 corresponding to the first location. Likewise, the second user may transmit the dynamic elements 9 via the second device 19 and/or the second node 15 to control a second airplane or a second hot air balloon at a second location of the audiovisual media 7.

The network 5 may transmit the dynamic elements 9 to the nodes 13, 15, the first device 17 and/or the second device 19. The network 5 may transmit the dynamic elements 9 which may relate to, for example, a location and/or a position of the hot air balloon or the airplane of the second user to the first node 13 and/or the first device 17. Further, the network 5 may transmit the dynamic elements 9 to the second node 15 and/or the second device 19 which may relate to, for example, a location and/or a position of the hot air balloon or the airplane of the first user. To this end, the first user and the second user may compete and/or may mutually participate in the game. The network 5 should not be deemed as limited to supporting a specific number of users.

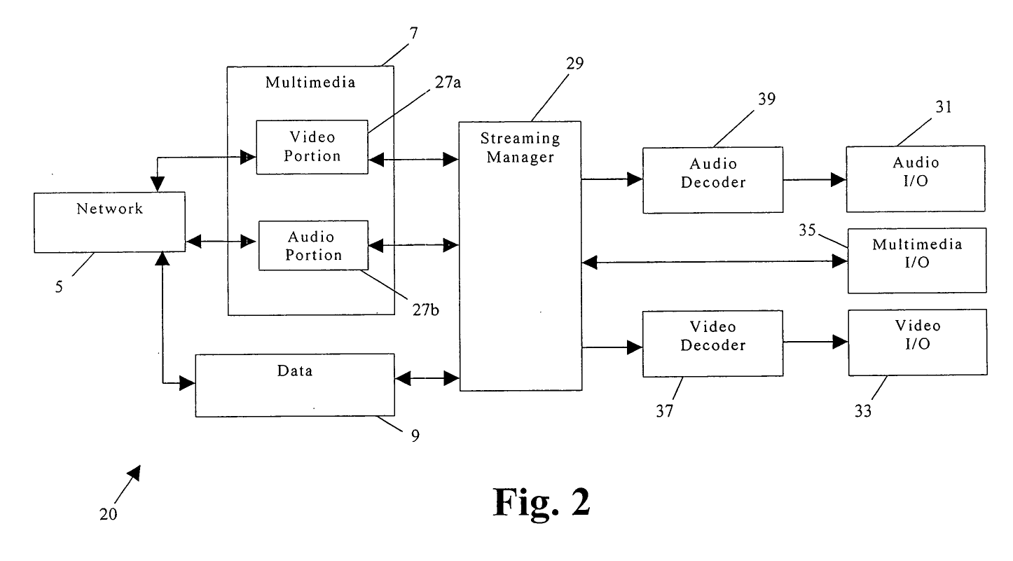

FIG. 2 illustrates a system 20 which may have the network 5 which may transmit and/or may receive the audiovisual media 7 and/or the dynamic elements 9. The audiovisual media 7 may have, for example, a video portion 27a and/or an audio portion 27b. The network 5 may transmit and/or may send the video portion 27a independently with respect to the audio portion 27b. The network 5 may encode and/or may format the video portion 27a into, for example, the first standard dynamic elements format. The network 5 may encode and/or may format the audio portion 27b in to, for example, the second standard dynamic elements format.

Alternatively, the network 5 may send and/or may transmit the video portion 27a and the audio portion 27b simultaneously. In such an embodiment, the network 5 may send and/or may transmit the audiovisual media 7 having the video portion 27a and the audio portion 27b. In an embodiment, the audiovisual media 7 may be transmitted and/or may be sent to a streaming manager 29 which may separate and/or may distinguish the video portion 27a from the audio portion 27b.

The streaming manager 29 may be connected to, may be in communication with and/or may be incorporated into the network 5. In addition, the streaming manager 29 may be connected to and/or may be in communication with an audio node 31, a video node 33 and/or a multimedia node 35. The streaming manager 29 may transmit the dynamic elements 9, the video portion 27a and/or the audio portion 27b from the audio node 31, the video node 33 and/or the multimedia node 35. The streaming manager 29 may provide an ability and/or a capability to transmit and/or to send the video portion 27a, the audio portion 27b and/or the dynamic elements 9 to.the audio node 31, the video node 33 and/or the multimedia node 35 independent of the standard format of the dynamic elements 9, the video portion 27a and/or the audio portion 27b. To this end, the streaming manager 29 may store multiple operating systems, applications, software, subscriptions and/or the like. The streaming manager 29 may provide, for example, a centralized location for transmitting and/or receiving applications, software, subscriptions and/or dynamic elements related to and/or associated with processing the dynamic elements 9 and/or the audiovisual media 7.

The network 5 and/or the streaming manager 29 may encode and/or may format the video portion 27a, the audio portion 27b and/or the dynamic elements 9. In an embodiment, the streaming manager 29 may transmit the video portion 27a to a video decoder 37. The video portion 27a may be encoded and/or may be formatted in, for example, the first standard format. The video decoder 37 may convert and/or may decode the video portion 27a into, for example, the second standard format. The first standard format may be different than the second standard format. The video decoder 37 may transmit and/or may send the video portion 27a to the video node 33 in, for example, the first format and/or the second format.

In an embodiment, the streaming manager 29 may transmit and/or may send the audio portion 27b to an audio decoder 39. The audio portion 27b may be transmitted and/or may be sent from the network 5 in the first standard dynamic elements format. The audio decoder 39 may convert and/or may decode the audio portion 27b into, for example, the second standard format. The audio decoder 39 may transmit and/or may send the audio portion 27b to the audio node 31 in, for example, the first standard format and/or the second format. The video decoder 37 and/or the audio decoder 39 may be connected to and/or may be incorporated into the streaming manager 29. In an embodiment, the video decoder 37 and/or the audio decoder 39 may be incorporated into the streaming manager 29.

In an embodiment, the streaming manager 29 may transmit and/or may send the dynamic elements 9 to the multimedia node 35. The dynamic elements 9 may be sent and/or may be transmitted from the multimedia node 35 to the streaming manager 29. The multimedia node 35 may be remote with respect to the audio node 31 and/or the video node 33.

The multimedia node 35 may be, for example, a audiovisual media input/output component of the first device 17 and/or the second device 19, such as, for example, a audiovisual media node. The audiovisual media input/output component may be, for example, a processor, a central processing unit, a dynamic elementsbase, a memory, a touch screen, a joystick and/or the like. In an embodiment, the multimedia node 35 may be the first node 13 and/or the second node 15. The multimedia node 35 may be incorporated into the first device 17 and/or the second device 19.

In an embodiment, the multimedia node 35 may transmit and/or may receive the video portion 27a, the audio portion 27b and the dynamic elements 9. To this end, the video node 33 and/or the audio node 11 may be incorporated into the multimedia node 35. Alternatively, the audio node 31 and/or the video node 33 may be in communication with and/or connected to the multimedia node 35.

A user (not shown) of the audio node 21, the video node 33 and/or the multimedia node 35 may input, for example, dynamic elements, such as, for example, commands, requests, communications and/or controls of the audiovisual media 7. In an embodiment, the dynamic elements 9 may be controls and/or commands received from the user which may relate to processing and/or interacting with the audiovisual media 7. For example, the controls and/or the commands received form the user may be, for example, to move a graphic of the audiovisual media 7 from a first location to a second location.

The audio node 21, the video node 33 and/or the multimedia node 35 may output the multimedia scene 10. In an embodiment, the audio node 31 may output, for example, audio transmission and/or audio sounds related to and/or associated with the multimedia scene 10. The video node 33 may output video transmissions related to and/or associated with the multimedia scene 10. The multimedia node 35 may output the dynamic elements 9 related to and/or associated with the multimedia scene 10.

In use, the multimedia scene 10 may be, for example, a game, such as, for example, an underwater exploration game. The game may have, for example, a submarine which may travel and/or may move through an underwater environment. The submarine may have lights which may illuminate a dark environment surrounding the submarine. The game may have, for example, interactive components and/or dynamic aspects.

In an embodiment, the game may be, for example, simulated by utilizing the audiovisual media 7 and/or the dynamic elements 9 stored on the network 5 in combination with and/or in conjunction with the audiovisual media 7 and/or the dynamic elements 9 stored on the audio node, the video node and/or the multimedia node. In such an embodiment, the system 3 illustrated in FIG. 1 may utilize the audiovisual media 7 and/or the dynamic elements 9 stored on the network 5 and the audiovisual media 7 and/or the dynamic elements 9 stored on the nodes 13, 15, the first device 17 and/or the second device 19.

As illustrated in FIG. 2, the network 5 may transmit and/or may send the video portion 27a to the video node 33. The multimedia node 35 may transmit and/or may send the dynamic elements 9 which may relate to, for example, a location of the submarine, a position of the submarine and/or movement of the submarine to the network 5. The video node 33 may display and/or may output a first portion of the video portion 27a. For example, the lights on the submarine may illuminate a first section of the underwater environment. As a result, the video node 27a may display and/or may output the first portion of the video portion 27a which may correspond to and/or may be based on the first section of the underwater environment.

As set forth above, the audiovisual media 7 and/or the dynamic elements 9 stored on the network 5 may be output and/or may be displayed in conjunction with the audiovisual media 7 and/or the dynamic elements 9 stored on the audio node 31 and/or the video node 31 as the multimedia scene 10. In an embodiment, the audio node 31, the video node 33 and/or the multimedia node 35 may store the audiovisual media 7 and/or the dynamic elements 9 which may relate to dynamic components and/or interactive elements of the game. For example, the user may control the lights of the submarine via the video node and/or the multimedia node. In such an embodiment, control of the lights of the submarine via the video node 33 and/or the audio node 31 may be preferred to control of the lights by the network 5. The network 5 may have, for example, a lag time between a time that a user inputs a command and a time that the game displays an effect and/or a result of the command. For controls that require a small amount of lag time, such as, for example, turning the lights of a submarine on or off, the controls may be stored in the audio node 31, the video node 33 and/or the multimedia node 35. To this end, the audio node 31, the video node 33 and/or the multimedia node 35 may store the audiovisual media 7 and/or the dynamic elements 9 relating to the controls and/or interactions that require the small amount of the lag time.

In an embodiment, the multimedia node 35, the video node 33 and/or the audio node 31 may output and/or may display the dynamic elements 9 and/or the audiovisual media 7 which form the multimedia scene 10. To this end, the audiovisual media 7 and the dynamic elements 9 may be displayed and/or may be output simultaneously to form and/or to create the multimedia scene 10.

The network 5 and/or the streaming manager 29 may provide, for example, a network protocol, such as, for example, dynamic elements communication protocol for transferring the audiovisual media 7 and/or the dynamic elements 9 from the network 5 to the audio node 31, the video node 33 and/or the multimedia node 35. The network 5 and/or the streaming manager 29 may determine the network protocol for transmitting and/or for sending the audiovisual media 7 and/or the dynamic elements 9 from the network 5 to the audio node 31 and/or the video node 33. In an embodiment, the multimedia node 35 may connect to and/or may communicate with the network 5 and/or the streaming manager 29. The multimedia node 35 may transmit and/or may send communication information, such as, for example, information and/or dynamic elements relating to capabilities and/or requirements of the audio node 31 and/or the video node 33. For example, the multimedia node 35 may transmit information and/or dynamic elements to the streaming manager 29 which may relate to an amount of memory and/or storage capacity of the audio node 31 and/or the video node 33.

Furthermore, the network 5 and/or the streaming manager 29 may transmit and/or may send control information, such as, for example, dynamic elements and/or information relating to the capabilities and/or requirements of the network 5 and/or the streaming manager 29 to the multimedia node 35. The network 5 and/or the streaming manager 29 may determine which dynamic elements and/or which interactive controls to store in the audio node 31 and/or the video node 33 based on the communication information of the network 5, the audio node 31 and/or the video node 33. In addition, the network 5 and/or the streaming manager 29 may determine and/or may choose the communication protocol for transmitting the audiovisual media 7 and/or the dynamic elements 9 to the audio node 31 and/or the video node 33. The network 5 and/or the streaming manager 29 may determine the communication protocol based on the communication information of the audio node 31 and/or the video node 33.

Moreover, the multimedia node 35 may determine the communication protocol for transmitting the audiovisual media 7 and/or the dynamic elements 9 to the network 5 and/or the streaming manager 29. The multimedia node 35 may determine the communication protocol based on the communication information of the network 5 and/or the streaming manager 29.

In an embodiment, the multimedia node 35 may transmit and/or may send, for example, a preferred communication protocol for transmitting the audiovisual media 7 and/or the dynamic elements 9 to the audio node 31 and/or the video node 33. The network 5 and/or the streaming manager 29 may transmit, for example, a preferred communication protocol for receiving the audiovisual media 7 and/or the dynamic elements 9 from the multimedia node 35.

Furthermore, in an embodiment, the network 5 and the streaming manager 29 may communicate via a first communication protocol. The streaming manager 29 and the multimedia node 35 may communicate via a second communication protocol. In addition, the audio node 31 and/or the video node 33 and the streaming manager 29 may communicate via a third communication protocol and/or a fourth communication protocol, respectively.

A type of communication protocol used may depend on, for example, volume of the audiovisual media 7 and/or the dynamic elements 9, type and/or format of the audiovisual media 7 and/or the dynamic elements 9, whether the audiovisual media 7 and/or the dynamic elements 9 is subject to loss and/or the like. In addition, the type of communication protocol used may depend upon an amount of the audiovisual media 7 and/or the dynamic elements 9 stored on the audio node 31, the video node 33 and/or the multimedia node 35 as compared to the amount of the audiovisual media 7 and/or the dynamic elements 9 stored on the network 5.

In an embodiment, the audiovisual media 7 and/or the dynamic elements 9 may be transmitted and/or may be sent from the network 5 using dynamic elements communication protocol, such as, for example, RTP. In some situations, the dynamic elements communication protocol may be subject to packet loss of the audiovisual media 7 and/or the dynamic elements 9. In such situations, the communication protocol may be changed to a different communication protocol which may prevent packet loss. For example, the communication protocol may be changed from RTP to RTP interleaved within RTSP/TCP.

The audiovisual media 7 and/or the dynamic elements 9 sent and/or transmitted from the network 5 may form, for example, the multimedia scene 10. Further, the multimedia scene 10 may have, for example, portions, sections and/or segments which are updated as the network 5 transmits the audiovisual media 7 and/or the dynamic elements 9. The multimedia scene 10 may be used to, for example, aggregate various natural and/or synthetic audiovisual objects and/or render the final scene to the user. For example, the multimedia scene 10 for the hot air balloon game may be a zoom view of the terrain due to the user decreasing an altitude of the hot air balloon. In an embodiment, the multimedia scene 10 may be illuminated portions of the underwater environment resulting from the user moving the submarine and/or the lights of the submarine from a first location of the underwater environment to a second location of the underwater environment. Scene updates may be encoded into, for example, SVG. The multimedia scene 10 may be transferred, encoded and/or received via lightweight application scene representation (“LASeR”).

The application dynamic elements may be, for example, software, software patches and/or components, computer applications, information for processing and/or for accessing the audiovisual media 7 and/or the dynamic elements 9 and/or the like. In an embodiment, the application dynamic elements may be encoded in a format, such as, for example, an XML language distinct from SVG.

In an embodiment, the dynamic elements 9 transmitted from the audio node 31, the video node 33 and/or the multimedia node 35 to the network 5 may be, for example, information on applied controls and/or low level user inputs. The information on applied controls and/or the low level user inputs may be, for example, information and/or dynamic elements related to controlling and/or interacting with dynamic and/or interactive components of the multimedia scene 10. In an embodiment, the information on applied controls for the hot air balloon game may be, for example, turning on a burner of the hot air balloon to lift the hot air balloon. In an embodiment, the low level user input may, for example, a pressed button, a rotating knob, an activated switch and/or the like. An amount of detail in the dynamic elements 9 transmitted from audio node 31, the video node 33 and/or the multimedia node 35 may be based on an amount of the application dynamic elements stored locally with respect to the user. For example, SVG has definitions for user interface events, such as, pressing a button and/or rotating a knob. Interface events not defined by SVG may be defined and/or may be created in, for example, an extension to uDOM.

The audiovisual media 7 and/or the dynamic elements 9 may be transmitted from the audio node 31, the video node 33 and/or the multimedia node 35 to the network 5 and/or the streaming manager 29 via, for example, a communication protocol, such as, for example, HTTP, RTCP and/or the like. The audiovisual media 7 and/or the dynamic elements 9 may be encoded by the audio node 31, the video node 33 and/or the multimedia node 35 into the dynamic elements format, such as, for example XML. In an embodiment, XML may require more network bandwidth and/or more processing requirements than available in the system 20. In such an embodiment, XML may be used in conjunction with, for example, a compression algorithm and/or a compression method to map the XML to a binary sequence, such as, for example, a universal lossless compression algorithm (e.g. gzip), binary MPEG format for XML (“BiM”) and/or the like.

The systems 3, 20 may have the network 5 which may be in communication with and/or may be connected to the audio node 31, the video node 33 and/or the multimedia node 35. The network 5 may transmit the audiovisual media 7 and/or the dynamic elements 9 to the audio node 31, the video node 33 and/or the multimedia node 35. The network 5, the audio node 31, the video node 33 and/or the multimedia node 35 may encode and/or may format the audiovisual media 7 and/or the dynamic elements 9. The streaming manager 29, the audio decoder 39 and/or the video decoder 37 may convert, may decode and/or may format the audiovisual media 7 and/or the dynamic elements 9. The streaming manager 29 may transmit the dynamic elements 9 and/or the audiovisual media 7 to the audio node 31, the video node 33 and/or the multimedia node 35 based on the dynamic elements 9. The audio node 31, the video node 33 and/or the multimedia node 35 may output the multimedia scene 10 which may incorporate the audiovisual media 7 and the dynamic elements 9.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for delivering interactive experiences, the system comprising:
a network that transmits first audiovisual media;
a portable device that receives the first audiovisual media from the network;
a first multimedia scene consumed on the portable device wherein the multimedia scene is provided by the first audiovisual media;
data transmitted from the portable device to the network; and
second audiovisual media transmitted by the network to the portable device in response to the data received from the portable device wherein the second audiovisual media provides a second multimedia scene for consumption on the portable device.

2. The system of claim 1 further comprising:
a streaming manager connected to the network and the portable device wherein the streaming manager controls processing of the first audiovisual media into the first multimedia scene.

3. The system of claim 1 further comprising:
a decoder connected to the network that converts the first audiovisual media from a first format to a second format.

4. The system of claim 1 further comprising:
a user interface that accepts user input on the portable device wherein the data transmitted to the network conveys the user input.

5. The system of claim 1 further comprising:
an output component of the portable device wherein the output component provides consumption of the first multimedia scene and the second multimedia scene.

6. The system of claim 1 further comprising:
a dynamic element displayed on the portable device wherein transmittal of the data from the portable device to the network moves the dynamic element from a first position in the first multimedia scene to a second position in the second multimedia scene.

7. The system of claim 1 further comprising:
an audio component of the first audiovisual media wherein the audio component is transmitted separately from a video component of the first audiovisual media.

8. A system for transmitting interactive elements between users, the system comprising:
a network that transmits audiovisual media;
a first portable device that receives the audiovisual media from the network;
a second portable device that receives the audiovisual media from the network;
a first multimedia scene consumed on the first portable device and the second portable device wherein the first multimedia scene is provided by the audiovisual media;
data transmitted from the first portable device in response to user input; and
a second multimedia scene consumed on the second portable device in response to the data transmitted from the first portable device.

9. The system of claim 8 further comprising:
a streaming manager connected to the network and the first portable device wherein the streaming manager controls processing of the audiovisual media into the first multimedia scene.

10. The system of claim 8 wherein the data is transmitted from the first portable device to the second portable device.

11. The system of claim 8 wherein the data is transmitted from the first portable device to the network.

12. The system of claim 8 further comprising:
a user interface that accepts the user input on the first portable device wherein the data transmitted by the first portable device conveys the user input.

13. The system of claim 8 further comprising:
a dynamic element displayed on the second portable device wherein transmittal of the data from the first portable device moves the dynamic element from a first position in the first multimedia scene to a second position in the second multimedia scene.

14. The system of claim 8 further comprising:
a third multimedia scene consumed on the first portable device in response to the data transmitted from the first portable device.

15. A method for providing interactive multimedia to multiple users, the method comprising the steps of:
receiving audiovisual media on a first portable device and a second portable device;
displaying a first multimedia scene on the first portable device and the second portable device wherein the first multimedia scene is derived from the audiovisual media;
receiving input on the first portable device;
transmitting data from the first portable device in response to the input; and
displaying a second multimedia scene on the second portable device in response to the data transmitted from the first portable device wherein the second multimedia scene is different than the first multimedia scene.

16. The method of claim 15 further comprising the step of:
displaying a third multimedia scene on the first portable device wherein the input on the first portable device initiates display of the third multimedia scene.

17. The method of claim 15 further comprising the step of:
transmitting the data from the first portable device to the second portable device.

18. The method of claim 15 further comprising the step of:
transmitting the data from the first portable device to a network wherein the network initiates display of the second multimedia scene on the second multimedia device.

19. The method of claim 15 further comprising the step of:
converting the audiovisual media from a first format to a second format.

20. The method of claim 15 further comprising the step of:
transmitting an audio component of the audiovisual media separately from a video component of the audiovisual media.
